(19) United States
(12) Patent Application Publication
(10) Pub. No.: US 2011/0125389 A1
(43) Pub. Date: May 26, 2011

(54) METHOD FOR THE DETERMINATION OF THE ACTUAL QUANTITY OF FUEL INJECTED IN AN INTERNAL COMBUSTION ENGINE

(75) Inventors: Tommaso DE FAZIO, Bologna (IT); Michele BASTIANELLI, Camerano (IT)

(73) Assignee: GM GLOBAL TECHNOLOGY OPERATIONS, INC., Detroit, MI (US)

(21) Appl. No.: 12/949,711

(22) Filed: Nov. 18, 2010

(30) Foreign Application Priority Data
Nov. 20, 2009 (GB) 0920373.8

(51) Int. Cl. F02D 41/30; G06F 19/00

(52) U.S. Cl. 701/103; 702/24

(57) ABSTRACT

A method is provided for the determination of the actual quantity of fuel injected in an internal combustion engine, in particular a Diesel engine. The engine includes, but is not limited to an inlet line and an exhaust line, at least one cylinder and at least an injector for each of the cylinders. The method includes, but is not limited to, during a fuel cut-off state of the engine, at least an injection into one of the cylinders of a nominal fuel test quantity and, in correlation to the test injection, a determination of the air flow quantity MAF at the inlet of the engine, a determination of the parameter λ in the exhaust line of the engine, and a calculation of the actual quantity of fuel Q_{fuel} injected in the test injection using the Electronic Control Unit of the engine.

### CROSS-REFERENCE TO RELATED APPLICATION

This application claims priority to British Patent Application No. 0920373.8, filed Nov. 20, 2009, which is incorporated herein by reference in its entirety.

### TECHNICAL FIELD

The technical field relates to method for the determination of the actual quantity of fuel injected in an internal combustion engine, in particular a Diesel engine.

### BACKGROUND

It is known that, in order to improve emissions and combustion noise in diesel engines, a multiple fuel injection pattern can be used, such pattern being substantially composed of a split of the requested fuel quantity into several injections. Those injections may comprise first a so-called pilot injection, namely a very early injection inside such multi-injection pattern, such pilot injection being a torque forming injection.

Subsequently one or more pre-injections may be provided in sequence, also these injections being torque forming. Then a main injection is performed, which is the basic injection inside the multi-injection pattern and also a torque forming injection, this main injection is generally performed just before the Top Dead Center (TDC) of the piston. The an after injection is performed which, in general, is a partially torque forming injection, being it possible to consider it as it were composed of two parts: a torque forming injection and a no-torque forming injection. Finally one or more post injections may be performed which are very late injections and are not torque forming.

In the present description the term “pilot” indicates a generic small fuel quantity, typically in the region of approximately 1 mm³/stroke, injected before the main injection. The pilot injection has an effect on combustion noise and emissions, in particular Particulate Matter (PM), and it is generally mapped in the Electronic Control Unit (ECU) of the vehicle taking into account a nominal system, namely a system that has components with no drift. A drift in pilot injected quantity compared with the desired value during vehicle lifetime causes an increase in combustion noise and emissions, in particular PM.

Generally speaking, pilot injected quantity drift may be caused by injector drift, rail pressure sensor drift, injector backflow pressure drift or by other conditions that may occur during lifetime of the vehicle. Of the above mentioned cause, the most critical is the injector drift.

With present injector technology, the actually injected fuel quantity, in each cylinder and for each injection, can be different from the desired or nominal fuel quantity. This undesirable condition may result due to several reasons and basically due to dispersion on injection characteristics due to the production spread or drift of injection characteristic due to aging of the injection system.

Present injector production processes are actually not precise enough to produce injectors with tight tolerances. Moreover those tolerances tend to get worse with aging during injector lifetime. As a result of all these factors, taking as an example the case of a solenoid injector, for a given energizing time at a given rail pressure, the actually injected fuel quantity can be different injector-by-injector. This problem is particularly critical for the small quantities, whose good precision and repetitiveness is needed in order to achieve emissions and combustion noise goals. On this basis, there is the need of a function that allows learning the actually injected small fuel quantities and making some adjustments in the fuel injection path in order to achieve an actually injected fuel quantity equal to the desired one.

A general approach to detect and correct the small quantities comprise a learning phase to detect in some way the actually injected small quantities cylinder-by-cylinder and a modifying phase of the cylinder-by-cylinder fuel injected quantity by means some corrections.

Prior solutions estimate the actually injected small fuel quantity on the basis of input signals deriving from different kinds of sensors such as knock sensors or on the basis of the crankshaft wheel signal. Such tests are performed at predetermined time intervals and repeated for each cylinder of the engine. The major drawback of these prior solutions lies in the fact that such fuel quantity estimation is indirect: a signal that shows a good correlation with actually injected quantity is analyzed. But these signals, for example the crankshaft wheel signal or other signals, are easily affected by noise and all sorts of disturbances coming from external environment such as rough roads, electric loads or other external or internal conditions, in such a way that the resulting estimation is certainly not sufficiently accurate.

In view of the foregoing, at least object is to provide a reliable calculation of the actual quantity of fuel injected in small quantity injections, independently of external disturbances. At least a further object is to use such reliable calculation of the actual quantity of fuel injected in order to correct the injection strategy in all those cases in which the behavior of the injector drifts significantly from nominal conditions, such correction being especially relevant for small injections. At least another object is to provide a method for the determination of the quantity of fuel injected in an internal combustion engine that may operate without using complex devices and by taking advantage from the computational capabilities of the Electronic Control Unit (ECU) of the vehicle and of the sensing devices generally present in the vehicle. At least another object of the present invention is to meet these goals by means of a rational and inexpensive solution. In addition, other objects, desirable features and characteristics will become apparent from the subsequent summary and detailed description, and the appended claims, taken in conjunction with the accompanying drawings and this background.

### SUMMARY

A method is provided for the determination of the actual quantity of fuel injected in a internal combustion engine, in particular a Diesel engine, the engine comprising an inlet line and an exhaust line, at least one cylinder and at least an injector for each of said cylinders, the method comprising, during a fuel cut-off state of the engine, at least an injection into one of said cylinders of a nominal fuel test quantity and, in correlation to said test injection, a determination of the air flow quantity MAF at the inlet of the engine, a determination of the parameter λ in the exhaust line of the engine, and a calculation of the actual quantity of fuel Q_{fuel} injected in said test injection using the Electronic Control Unit of the engine on the basis of a function of the air flow quantity MAF and of the parameter λ so determined. Preferably the calculation of the actual quantity of fuel Q_{fuel} is performed by means of the relationship

$$Qfuel = \frac{MAF}{λ}$$

evaluated at the stoichiometric ratio.

According to an embodiment, the value of the actual injected quantity is compared with the nominal quantity of fuel in order to perform a correction of the injection strategy. Preferably the determination of the parameter λ in the exhaust line is performed by a lambda sensor. Also, the determination of the air flow quantity MAF may be performed by a mass air flow sensor in the inlet line of the engine. The calculation of the quantity of fuel Q_{fuel} injected may be performed at predetermined or random time intervals for each cylinder of the engine.

The method can be realized in the form of a computer program comprising a program-code to carry out the steps of the method and in the form of a computer program product comprising means for executing the computer program. The computer program product comprises, according to an embodiment, a control apparatus for an IC engine, for example the ECU of the engine, in which the program is stored so that the control apparatus operates in the same way as the method. In this case, when the control apparatus executes the computer program, the steps of the method are carried out.

The method can be also realized in the form of an electromagnetic signal. The signal being modulated to carry a sequence of data bits which represent a computer program to carry out the steps of the method. An internal combustion engine is also provided that is arranged for carrying the method.

### BRIEF DESCRIPTION OF THE DRAWINGS

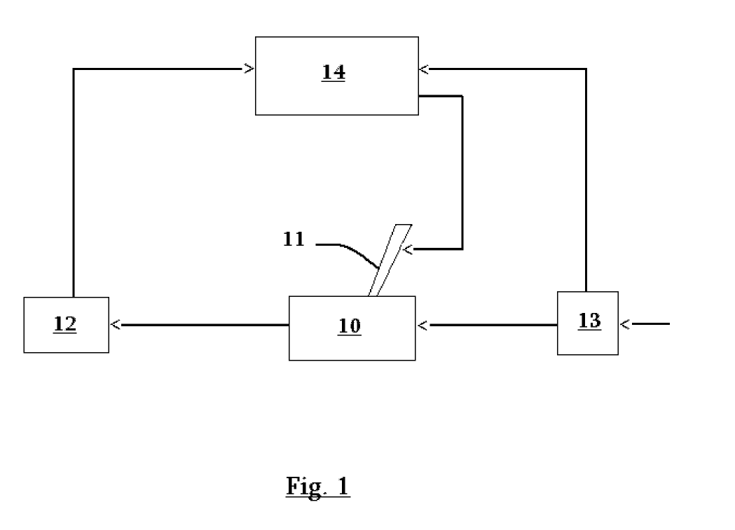

The present invention will hereinafter be described in conjunction with the following drawing FIG. 1, which is a schematic diagram of the main components of the engine that allow actuation of the method of an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

An embodiment of the invention provides for a method for the determination of the quantity of fuel injected in an internal combustion engine 10, in particular a Diesel engine, whereby the engine 10 comprises one or more cylinders, each cylinder having a respective injector 11. The method may be applied, in particular, but not exclusively, to small fuel injections, whereby such term in the present description refers to fuel injections comprised between the minimum possible quantity the injector is capable to achieve and about 2 mm³/stroke.

Preliminary it is noted that:

$$λ = \frac{MAF}{( Qfuel * 14.56 )} \qquad ( 1 )$$

Where 14.56 is the stoichiometric ratio of Diesel fuel, or in other words the ratio (MAF/Q_{fuel})_{ST}. Other stoichiometric ratios for different fuels or blends thereof may be considered. In this equation (1) above, MAF is the Mass Air Flow that can be measured by a suitable sensor 13 and Q_{fuel} is the quantity of fuel injected. It is also known that the above parameter λ can be measured by a lambda sensor 12 in the exhaust line of the engine.

The method is performed during a fuel cut-off, by injecting a nominal small fuel test quantity into the respective cylinder, the quantity typically having a value around pilot injection quantity and being without effects on the torque. As a non limitative example, the nominal fuel test quantity may be 1 mm³ of fuel. A fuel cut-off condition is generated when the accelerator pedal is released by the driver.

A first step of the method provides for a determination of the air flow quantity MAF, performed by a mass air flow sensor 13 in the inlet line of the engine. Moreover the exhaust effects of the test injection in a fuel cut-off condition are sensed by an oxygen sensor installed in the exhaust line. Specifically, in a step of the method, a determination of the parameter λ in the exhaust line is performed by a lambda sensor 12.

On the basis of these measures, the ECU 14 of the engine performs a calculation of the actual quantity of fuel Q_{fuel} injected using the parameters above determined. Preferably the method is performed using the following relationship derived from equation (1):

$$Qfuel = \frac{MAF}{λ}$$

evaluated at the stoichiometric ratio.
At this point the quantity actually injected and thus calculated may be compared with the nominal quantity, in order to determine a possible difference. When such difference is determined, a corrected injection strategy may be implemented in order to take account of the drift of the system. In particular, such corrected injection strategy may comprise a correction of the final energizing time of the injector 11 or other suitable strategies.

In order to take account of further drift that may influence the injectors during time the method is performed at predetermined or random time intervals. Furthermore since injector drift may vary between the various injectors of the same engine, due to tolerances of production or any other factor, method of the invention is performed at predetermined or random time intervals for each cylinder of the engine.

The embodiments of invention have several important advantages and benefits. First, by getting an estimation of the actual injected fuel quantity into a diesel engine, the invention allows to perform some injector specific corrections, in order to get an actual pilot injected fuel quantity equal to the desired or nominal one. As a consequence, a substantial reduction of emissions dispersion, normally due to drift in pilot injected fuel quantity, during vehicle lifetime can be achieved. As a further consequence, a reduction of combustion noise, also due to drift in pilot injected fuel quantity, during vehicle lifetime can also be achieved.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for a determination of an actual quantity of fuel injected in an internal combustion engine, the internal combustion engine comprising:
an inlet line;
an exhaust line;
a cylinder;
an injector for said cylinder,
the method comprising:
injecting a nominal fuel test quantity into the cylinder during a fuel cut-off state of the internal combustion engine,
determining an air flow quantity at the inlet line in correlation to the injecting the nominal fuel test quantity;
determining a parameter λ in the exhaust line; and
calculating the actual quantity of fuel injected in the injecting the nominal fuel test quantity using an Electronic Control Unit on at least a basis of a function of the air flow quantity and of the parameter λ.

2. The method according to claim 1, wherein the internal combustion engine is a Diesel engine

3. The method according to claim 1, wherein said calculating the actual quantity of fuel is performed in accordance with a relationship
$$Qfuel = \frac{MAF}{λ}$$
and evaluated at a stoichiometric ratio.

4. The method according to claim 1, further comprising comparing the actual quantity of fuel with the nominal fuel test quantity in order to perform an injection correction.

5. The method according to claim 4, wherein said injection correction comprises regulating an energizing time of the injector.

6. The method according to claim 1, wherein the determining the parameter λ in the exhaust line comprises sensing a lambda sensor.

7. The method according to claim 1, wherein the determining the air flow quantity comprises sensing a mass air flow sensor in the inlet line.

8. The method according to claim 1, wherein the calculating the actual quantity of fuel injected is performed at a predetermined interval.

9. The method according to claim 1, wherein the calculating the actual quantity of fuel injected is performed at a random time interval.

10. An internal combustion engine, comprising:
an inlet line;
an exhaust line;
a cylinder;
an injector for said cylinder,
a first sensor in the exhaust line adapted to sense a parameter λ;
a second sensor in the inlet line adapted to sense an air flow quantity; and
an electronic control unit configured to:
inject a nominal fuel test quantity into the cylinder during a fuel cut-off state of the internal combustion engine;
receive the air flow quantity at the inlet line from the second sensor in correlation to the injecting the nominal fuel test quantity;
receive the parameter λ from the first sensor; and
calculate an actual quantity of fuel injected with the nominal fuel test quantity on at least a basis of a function of the air flow quantity and of the parameter λ.

11. The internal combustion engine according to claim 10, wherein the internal combustion engine is a Diesel engine

12. The internal combustion engine according to claim 10, wherein the electronic control unit is configured to calculate the actual quantity of fuel in accordance with a relationship of
$$Qfuel = \frac{MAF}{λ}$$
and evaluate at a stoichiometric ratio.

13. The internal combustion engine according to claim 10, wherein the electronic control unit is further configured to compare the actual quantity of fuel with the nominal fuel test quantity in order to perform an injection correction.

14. The internal combustion engine according to claim 13, wherein said injection correction comprises a regulation of an energizing time of the injector.

15. The internal combustion engine according to claim 10, wherein the electronic control unit is configured to calculate the actual quantity of fuel injected at a predetermined interval.

16. The internal combustion engine according to claim 10, wherein the electronic control unit is configured to calculate the actual quantity of fuel injected at a random time interval.

17. A computer readable medium embodying a computer program product, said computer program product comprising:
a program for a determination of an actual quantity of fuel injected in an internal combustion engine, the internal combustion engine comprising:
an inlet line;
an exhaust line;
a cylinder;
an injector for said cylinder,
the program configured to:
inject a nominal fuel test quantity into the cylinder during a fuel cut-off state of the internal combustion engine,
determine and air flow quantity at the inlet line in correlation to the injecting the nominal fuel test quantity;
determine a parameter λ in the exhaust line; and
calculate the actual quantity of fuel injected in the injecting the nominal fuel test quantity using an Electronic Control Unit on at least a basis of a function of the air flow quantity and of the parameter λ.

18. The computer readable medium embodying the computer program product according to claim 17, wherein the internal combustion engine is a Diesel engine

19. The computer readable medium embodying the computer program product according to claim 17, wherein the actual quantity of fuel is calculated in accordance with a relationship of
$$Qfuel = \frac{MAF}{λ}$$
and evaluated at a stoichiometric ratio.

20. The computer readable medium embodying the computer program product according to claim 17, the program further configured to compare the actual quantity of fuel with the nominal fuel test quantity in order to perform an injection correction.

21. The computer readable medium embodying the computer program product according to claim 20, wherein said injection correction comprises regulating an energizing time of the injector.

22. The computer readable medium embodying the computer program product according to claim 17, wherein program is configured to determine the parameter λ in the exhaust line based at least in part on data from a sensor.

23. The computer readable medium embodying the computer program product according to claim 17, wherein the program is configured to determine the air flow quantity based at least in part on data from a sensor in the inlet line.

24. The computer readable medium embodying the computer program product according to claim 17, wherein the program is configured to calculate the actual quantity of fuel injected at a predetermined interval.

25. The computer readable medium embodying the computer program product according to claim 17, wherein the program is configured to calculate the actual quantity of fuel injected at a random time interval.
